(19) United States
(12) Patent Application Publication
(10) Pub. No.: US 2024/0151161 A1
(43) Pub. Date: May 9, 2024

(54) FLOOD RETENTION TANK

(71) Applicant: NUOVO PIGNONE TECNOLOGIE - SRL, Florence (IT)

(72) Inventors: Andrea MAGAROTTO, Florence (IT); Luca FRASSINELLI, Florence (IT); Venkata Rambabu DABIRU, Florence (IT)

(21) Appl. No.: 18/546,709

(22) PCT Filed: Feb. 17, 2022
(86) PCT No.: PCT/EP2022/025054

§ 371 Date: Aug. 16, 2023

(30) Foreign Application Priority Data
Feb. 17, 2021 (IT) 102021000003647

(51) Int. Cl. F01D 25/18

(52) U.S. Cl. CPC F01D 25/18; F05D 2220/32; F05D 2260/98

(57) ABSTRACT

A turbomachinery assembly, comprising a turbomachinery having an outlet oil pipe for collecting the exhaust oil of the turbomachine, and a collection manifold, connected to a main oil collection tank is disclosed. The turbomachinery assembly comprises also an oil flood retention tank for collecting the exhaust oil of the turbomachinery. The oil flood retention tank comprises inlet and outlet ports, wherein the inlet port is placed at a higher position with respect to the outlet port. Also disclosed is a flood retention tank.

### TECHNICAL FIELD

The present disclosure concerns a tank or a container in general, for the retention of the oil drained from the bearings of a gas turbine. The tank avoids the bearings flooding, in particular for gas turbines intended for an offshore installation.

### BACKGROUND ART

Gas turbines, and in particular, steam turbines, are installed either in onshore and offshore platforms. The latter is mainly used for extracting gas from deposits placed under the seabed.

The installation of the gas turbines in offshore platforms are often subject to a pitch and fluctuation, mainly due to the sea movement. Typical pitch values for offshore installations (5 to 10 degrees) require a high slope angle of lube oil drain manifold with consequent train centerline height increase and constraints on the position of the tank with respect to machines.

More specifically, any installations, such as turbomachinery, need lube oil, to operate and once this has lubricated the bearings, it has to be collected and processed. For example, turbomachinery for producing electrical energy, provides a gas turbine, a skid, namely a supporting base, on which the gas turbine is installed, and a main oil collection tank, usually arranged below the gas turbine, to collect the lube oil used for bearings lubrication and cooling, to be cooled and filtered and reintroduced into the gas turbine. The main oil collection tank is part of the skid, to save room on an offshore platform. The lube oil coming from the turbomachinery is drained from the latter to the oil tank through an oil drain manifold.

To prevent the lube oil contained into the oil tank or flowing through the oil drain manifold to come back to the gas turbine because of the pitch of the offshore platform, the oil drain manifold is arranged angled down, so as to compensate for possible refluxes. This implies necessarily that the oil tank has to be placed at a lower level than it could. This causes an increase in the overall size of the installation, as well as a more complex structure.

The above negatively affect the construction and the operation costs of the offshore.

Accordingly, an improved installation with a more compact size would be welcomed in the technology.

### SUMMARY

In one aspect, the subject matter disclosed herein is directed to a turbomachinery assembly, comprising an outlet oil pipe for collecting the drained oil of the turbomachine, such as a gas turbine, a collection manifold, and a main oil collection tank, for collecting drained oil coming from the turbomachinery. The collection manifold drains the lube oil coming from the bearings to the main oil collection tank. The turbomachinery assembly comprises an oil flood retention tank, allowing the accumulation of part of the oil flowing through the collection manifold when the turbomachine assembly tilts.

In another aspect, the subject matter disclosed herein concerns that the oil flood retention tank has an inlet port, obtained on the upper surface of the tank and connectable to the outlet oil pipe, and an outlet port, obtained on the lateral surface of the tank and connectable to the collection manifold.

In another aspect, disclosed herein is that the oil flood retention tank comprises a plurality of supporting legs to fix the tank.

A further aspect of the present disclosure is drawn to the fact that the oil retention tank comprises also anti-wave baffles arranged inside the tank, to limit sloshing effects during train rotation.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates a schematic of a perspective view of turbomachinery equipped with a flood retention tank according to a first embodiment;

FIG. 2 illustrates a detail of the turbomachinery of FIG. 1; and

FIG. 3 illustrates a flood retention tank according to a first embodiment.

### DETAILED DESCRIPTION OF EMBODIMENTS

The gas turbines are widely used in offshore platforms to supply energy to the several apparatuses of the platform itself. The gas turbines require lube oil to operate, like any mechanical machine. In particular, oil is used to lube the bearings of the gas turbine, to allow the rotation of the rotative parts. The lube oil of the bearings of the gas turbine drains from the gas turbine and it is collected in a suitable oil collection tank to be cooled and filtered, before being reused. Appropriate pipes connect the gas turbine with an oil collection tank. The offshore platforms are subject to pitch, because of, for example, the sea waves. This can cause the lube oil drained from the gas turbine to backflow toward the gas turbine. According to one aspect, the present subject matter is directed to a flood retention tank interposed between the gas turbine and the oil collection tank, intended to collect any backflow of lube oil, directed toward the gas turbine, in case of the pitch of the offshore platform, end, then, of the gas turbine.

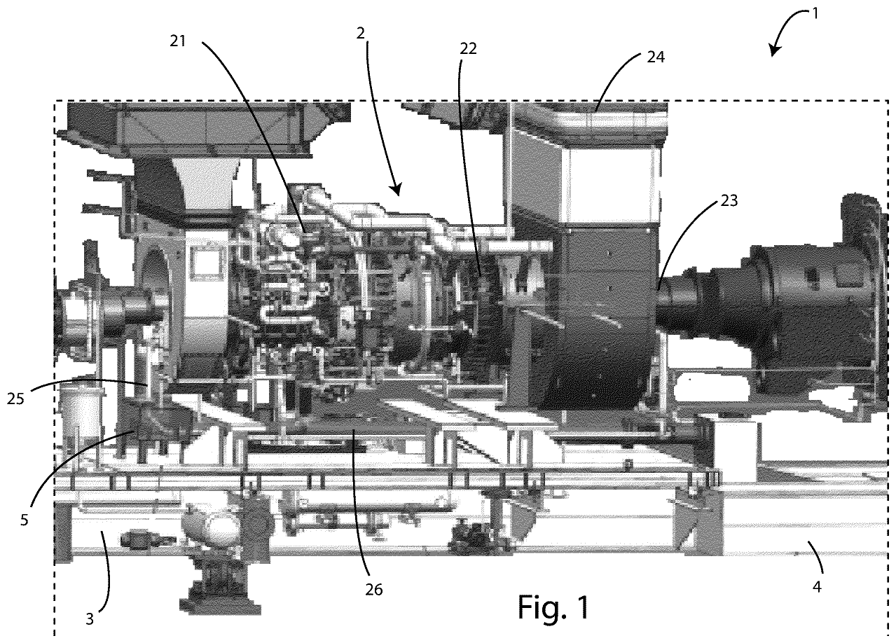

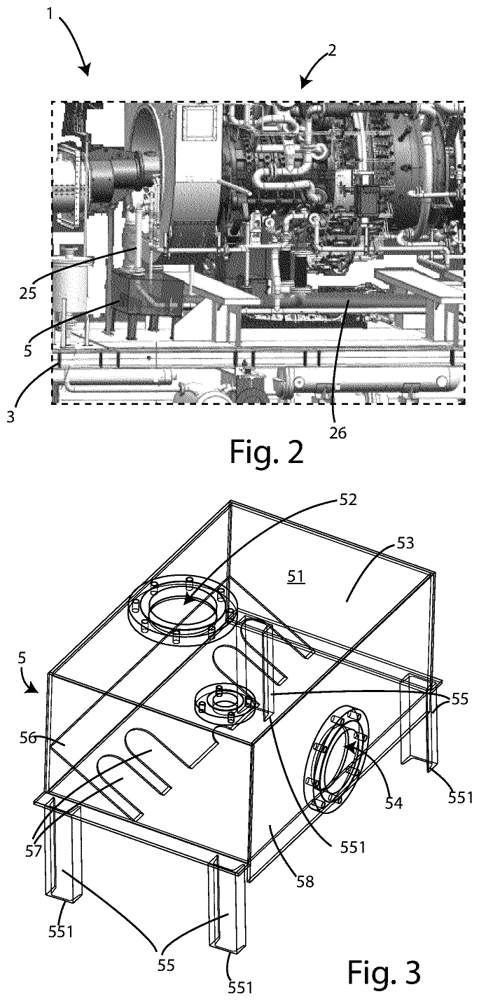

Referring now to the drawings, FIGS. 1 and 2 show a turbomachinery assembly, indicated with reference number 1, which can be installed in an offshore platform (not shown in the figures).

The turbomachinery assembly 1 comprises a gas turbine or turbomachinery in general, generally designated by the reference numeral 2, which is an axial turbine, and comprises a compressor 21, combustion chambers 22, equipped with fuel nozzles, and ignitors to burn the fuel ejected by the fuel nozzles, and one or more stages of power turbines (not shown in the figures), connected to an output shaft 23. The output shaft 23 is then connected to a generator (not shown in the figures) to generate electric energy or a gas compressor or a pump. The combustion exhaust gas is then ejected by exhaust stacks 24.

The gas turbine also comprises an outlet oil pipe 25, for the outflow of the lube oil from the turbomachinery 2, and a collection manifold 26, into which the exhausted oil from the outlet oil pipe 25 flows, as better explained below. The turbomachinery 1 also comprises a skid 3, to support the gas turbine 2. The skid 3 is arranged below the gas turbine 2.

The collection manifold 26 is arranged almost horizontally, namely parallel to the gas turbine 2 axis.

The turbomachinery 1 also includes a main oil tank 4, usually arranged below the gas turbine 2, to collect the lube oil. The main oil tank 4 is part of, or integral with the skid 3.

Also, the collection manifold 26 is connected to the main oil tank 4. The lube oil outflowing from the gas turbine 2 through the outlet oil pipe 25 is collected into the collection manifold 26.

The turbomachinery 1 also comprises a flood retention tank 5, arranged on the skid 2, close, and in the embodiment shown, just beneath, the turbomachinery 1. More structural details on the oil flood retention tank 5 will be given below, to better describe its operation.

In other embodiments, the oil flood retention tank 5 may be located in other positions. However, usually the flood retention tank 5 is placed at a lower level than the gas turbine 2, namely from the arrangement from which the exhausted lube oil comes from.

In general, the oil flood retention tank 5 is located the farthest position from the oil collection tank.

Referring also to FIG. 3 it is possible to see the flood retention tank 5, which defines a containment volume 51, where oil can be collected. In the embodiment, the flood retention tank 5 has the shape of a parallelepiped. In other embodiment, the flood retention tank 5 can have other shapes. By way of example, the oil flood retention tank 5 may be cubed, ellipsoidal, or it may even have an irregular shape, so as to adapt to possible irregular spaces.

The oil retention tank volume 51 is calculated considering the oil accumulated in the collection manifold 26 and the oil draining from bearings. The volume 51 is sized so that during this time interval equal to half of the typical wave period, the oil level in the retention tank will always allow air flow from bearings to the tank to guarantee oil mist eliminator depressurization effect downstream the bearings. Either the oil level will leave the outlet port 54 partially open to air passage or a vent pipe is included to connect the top of the retention tank to the top of collection manifold 26 in a position where the oil will never completely fill the drain manifold and free air passage to the main oil tank 4 will always remain available.

The flood retention tank 5 has an inlet port 52, connected to the outlet oil pipe 25, located or obtained at the upper surface 53 of the flood retention tank 5, and an outlet port 54, connected to the collection manifold 26, located or obtained at the lateral surface 55 of the oil flood retention tank 5. In other words, the flood retention tank is connected to the outlet oil pipe 25, and the collection manifold 26. The inlet port 52 is placed at a higher position with respect to the outlet port 54. The flood retention tank 5 also comprises also four supporting legs 55, each one equipped with a flange 551, to be fixed to the surface of the skid 3, by means of bold or any other fixing means.

The legs 55 have different heights so that the bottom plate 58 of the oil flood retention tank 5 has the same slope as the collection manifold 26.

In some embodiment, the oil flood retention tank 5 can have a plurality of inlet ports 52, and a plurality of outlet ports 54. In any case, all the outlet ports 54 are obtained in a lower position than any inlet ports 52.

In the embodiment shown the flood retention tank 5 also comprises an anti-wave baffle 56 (holed plates type), installed inside the containment volume 51 of the flood retention tank 5, to limit sloshing effects during train rotation. Each anti-wave baffles 54 is a bulkhead and has at least one bottom opening 57. More specifically, in the embodiment shown, the anti-wave baffle 56 has two bottom openings 57. The bottom openings 57 allow the distribution of the oil contained into the oil flood retention tank 5, allowing at the same time, the anti-wave baffles 56 to reduce the waves within the oil flood retention tank 5. The anti-wave baffle 56 can also be tilted.

Also, the flood retention tank 5 can be provided with more than one anti-wave baffle 56. In this case, the anti-wave baffles 56 are arranged to face each other and fixed to the bottom of the flood retention tank 5.

Also, the anti-wave baffles 56 are arranged in front of the outlet port 54.

In some embodiments, the flood retention tank 5 can be provided with no anti-wave baffles 53 or with a different number or shape of anti-wave baffles 53.

The flood retention tank 5 can be made of metal or any other material suitable to contain lube oil.

The flood retention tank 5 of the turbomachinery assembly 1 operates as follows.

When the turbomachinery 2, namely the gas turbine, of the turbomachinery assembly 1 operates, the exhausted lube oil of the gas turbine 2 is generated by the gas turbine 2 itself. The lube exhausted oil flows through the outlet oil pipe 25, inflowing the flood retention tank 5 through the inlet port 52, so as to be collected in the containment volume 51.

Since the outlet port 54 is placed at a lower position with respect to the inlet port 52, the lube oil contained in the flood retention tank 5 outflows from the tank 5 through the collection manifold 26, so as to reach the main oil collection tank 4.

In case of the pitch of the offshore installation, which can reach even 10 degrees, the lube oil flowing through the collection manifold 26 can flow back, so that the oil can accumulate into the flood retention tank 5. Also, because of the fact that the inlet port 52 is at a higher level than the outlet port 54, the lube oil is prevented from backflow through the outlet oil pipe 25, and therefore to the gas turbine 2.

Also, as mentioned, because of the different lengths of the legs 55, the bottom plate 58 of the oil flood retention tank 5 has the same slope of the collection manifold 26, thus there is no additional offset between the level of the oil and the collection manifold 26.

Also, in case of particularly wave motion, such as to induce stresses on the offshore platform, lube oil collected into the flood retention tank 5 is prevented to flow with excessive force through the collection manifold 26, thanks to the action of the anti-wave baffles 56, which simply interrupt the waves that may create into the flood retention tank 5.

An advantage of the installation of a flood retention tank is that the train centerline height is reduced and the package can be designed with a more compact layout.

In some embodiments, the outlet port 54 can be obtained in a different position: for example, it can be obtained on another side or at the bottom of the flood retention tank 5. In general, the outlet port 54 is arranged at a lower level then the inlet port 52, so that by gravity, the exhausted oil collected into the flood retention tank 5, collected because of any backflow of the same from the collection manifold 26, is forbidden to flow back to the turbomachinery 2 through the outlet oil pipe 25.

While aspects of the invention have been described in terms of various specific embodiments, it will be apparent to those of ordinary skill in the art that many modifications, changes, and omissions are possible without departing from the spirit and scope of the claims. In addition, unless specified otherwise herein, the order or sequence of any process or method steps may be varied or re-sequenced according to alternative embodiments.

Reference has been made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. Reference throughout the specification to “one embodiment” or “an embodiment” or “some embodiments” means that the particular feature, structure, or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures, or characteristics may be combined in any suitable manner in one or more embodiments.

When elements of various embodiments are introduced, the articles “a”, “an”, “the”, and “said” are intended to mean that there are one or more of the elements. The terms “comprising”, “including”, and “having” are intended to be inclusive and mean that there may be additional elements other than the listed elements.

1. A turbomachinery assembly, comprising:
a turbomachinery comprising an outlet oil pipe for collecting the lube oil drained from the turbomachinery, and a collection manifold;
a main oil collection tank, for collecting the drained lube oil of the turbomachinery, wherein the collection manifold is connected to the main oil collection tank to convey the drained lube oil into the main collection tank;
characterized in that the turbomachine assembly comprises an oil flood retention tank for collecting the drained lube oil of the turbomachinery having:
at least one inlet port, connected to the outlet oil pipe; and
at least one outlet port connected to the collection manifold;
wherein the inlet port is placed at a higher position with respect to the outlet port, so that part of the lube oil flowing through the collection manifold accumulates in the retention tank when the turbomachine assembly tilts.

2. The turbomachine assembly according to claim 1, wherein the oil flood retention tank has an upper surface and a lateral surface, wherein the inlet port is located, or obtained on the upper surface, and wherein the outlet port is located or obtained on the lateral surface.

3. The turbomachinery assembly according to claim 1, wherein the oil flood retention tank has the shape of a parallelepiped, a cube, an ellipsoid, or an irregular shape, so as to adapt to irregular spaces.

4. The turbomachinery assembly according to claim 1, further comprising a skid arranged below the turbomachinery, wherein the oil flood retention tank is fixed on the skid.

5. The turbomachinery assembly according to claim 4, wherein the oil flood retention tank comprises also a plurality of supporting legs, preferably four, each one equipped with a flange, to be fixed to the surface of the skid.

6. The turbomachinery assembly according to claim 5, wherein the oil flood retention tank has a bottom plate, and wherein the supporting legs have different heights so that the bottom plate has the same slope of the collection manifold.

7. The turbomachinery assembly according to claim 1, wherein the volume of the oil retention tank is calculated considering the oil accumulated in the collection manifold and the oil draining from the bearings of the turbomachinery and is sized so that during this time interval approximately equal to half of the typical wave period, so that the oil level in the oil flood retention tank allows air flow from bearings.

8. The turbomachine assembly according to claim 4, wherein the main oil collection tank is part of, or integral with the skid.

9. The turbomachinery assembly according to claim 1, wherein the oil flood retention tank comprises at least one anti-wave baffle, installed inside the containment volume, to limit sloshing effects during train rotation.

10. The turbomachinery assembly according to claim 9, wherein the oil flood retention tank comprises a plurality of anti-wave baffles, arranged facing each other.

11. The turbomachinery assembly according to claim 9, wherein each anti-wave baffle has at least one bottom opening, preferably two bottom openings.

12. The turbomachine assembly according to claim 1, wherein the turbomachinery is a gas turbine.

13. A retention tank for the retention of oil flood of a turbomachinery, wherein the turbomachinery comprises
an outlet oil pipe for collecting lubricating exhaust oil, and
a main collection manifold, connected to the outlet oil pipe, and wherein the retention tank has:
a containment volume; an inlet port connectable to the outlet oil pipe; and
an outlet port connectable to the main collection manifold;
wherein the inlet port is placed at a higher position with respect to the outlet port.

14. The retention tank according to claim 13, wherein the oil flood retention tank has an upper surface and a lateral surface, wherein the inlet port is located or obtained on the upper surface, and wherein the outlet port is located or obtained on the lateral surface.

15. The retention tank according to claim 13, wherein the retention tank has the shape of a parallelepiped, a cube, an ellipsoid, or an irregular shape, so as to adapt to irregular spaces.

16. The retention tank according to claim 13, further comprising a plurality of supporting legs, preferably four, each one equipped with a flange, for fixing the retention tank on a surface, wherein the oil flood retention tank has a bottom plate, and wherein the supporting legs have different heights so that the bottom plate has the same slope of the collection manifold.

17. The retention tank according to claim 13, wherein the volume of the retention tank is calculated considering the oil accumulated in the collection manifold, and the oil draining from the bearings of the turbomachinery and is sized so that during this time interval approximately equal to half of the typical wave period, so that the oil level in the oil flood retention tank allows air flow from bearings.

18. The retention tank according to claim 13, further comprising at least one anti-wave baffle, installed inside the containment volume, to limit sloshing effects during train rotation.

19. The retention tank according to claim 18, wherein the oil flood retention tank comprises a plurality of anti-wave baffle, arranged facing each other, and wherein each anti-wave baffle has at least one bottom opening, preferably two bottom openings.
